(19) United States
(12) Patent Application Publication
(10) Pub. No.: US 2005/0140505 A1
(43) Pub. Date: Jun. 30, 2005

(54) Locking mechanism

(76) Inventors: Glen William Wallis, Staffs (GB); Rob Todd, Newcastle Upon Tyne (GB)

Correspondence Address: MICHAEL BEST & FRIEDRICH, LLP, 100 E WISCONSIN AVENUE, MILWAUKEE, WI, 53202, US

(21) Appl. No.: 10/501,483

(22) PCT Filed: Jan. 13, 2003
(86) PCT No.: PCT/GB03/00098

(30) Foreign Application Priority Data
Jan. 14, 2002 (GB) 0200680.7

(51) Int. Cl. G08B 29/00

(52) U.S. Cl. 340/506; 70/256; 307/143; 340/5.7

(57) ABSTRACT

A locking mechanism is provided operable to restrict unauthorised access to a structure such as a house, the locking mechanism being operable to permit external access by means of at least two remote control devices (14), (21), one of the remote control devices (14) being arranged for use by an occupant of the structure and another of the remote control devices (21) being arranged for use by an authorised official such as a police officer, fire officer or safety officer (e.g. a doctor, nurse, paramedic or ambulance personnel).

The invention relates to locking mechanisms and particularly to electronic locking mechanisms for use with structures such as buildings.

More and more sophisticated locking mechanisms are becoming available, for example to secure a structural building such as a house, with a view to providing a high degree of security against unauthorised entry. However, a down side of the increased security is that if some problems should arise with the householder within the house, for example because of a fire or accident or illness, the householder can actually be put at an increased risk because it is more difficult for rescue services, for example, to enter the house.

The invention seeks to provide a locking mechanism which can provide a high degree of security against unauthorised entry, but facilitates authorised entry.

Accordingly, the invention provides a locking mechanism operable to restrict unauthorised access to a structure such as a house, the locking mechanism being operable to permit external access, by means of at least two remote control devices operable from outside the structure, one of the remote control devices being arranged for use by an occupant of the structure and another of the remote control devices being arranged for use by an authorised official such as a police officer, fire officer or safety officer (e.g. doctor, nurse, paramedic or ambulance personnel).

Preferably, the locking mechanism is associated with at least one internal safety device, for example a smoke detector or panic button, the locking mechanism being such that if the safety device is activated, this makes the locking mechanism susceptible to an entry signal from an associated external operating device.

For example, the locking mechanism may be such that if a smoke detector within a house is operated, then this will put the locking mechanism into a condition in which an operating device specifically allocated to fire officers will enable a fire officer to gain access to the house.

Similarly if a panic button is activated within a house, a doctor, nurse, paramedic or the like can gain access.

The invention includes a structure when fitted with a locking mechanism according to the invention.

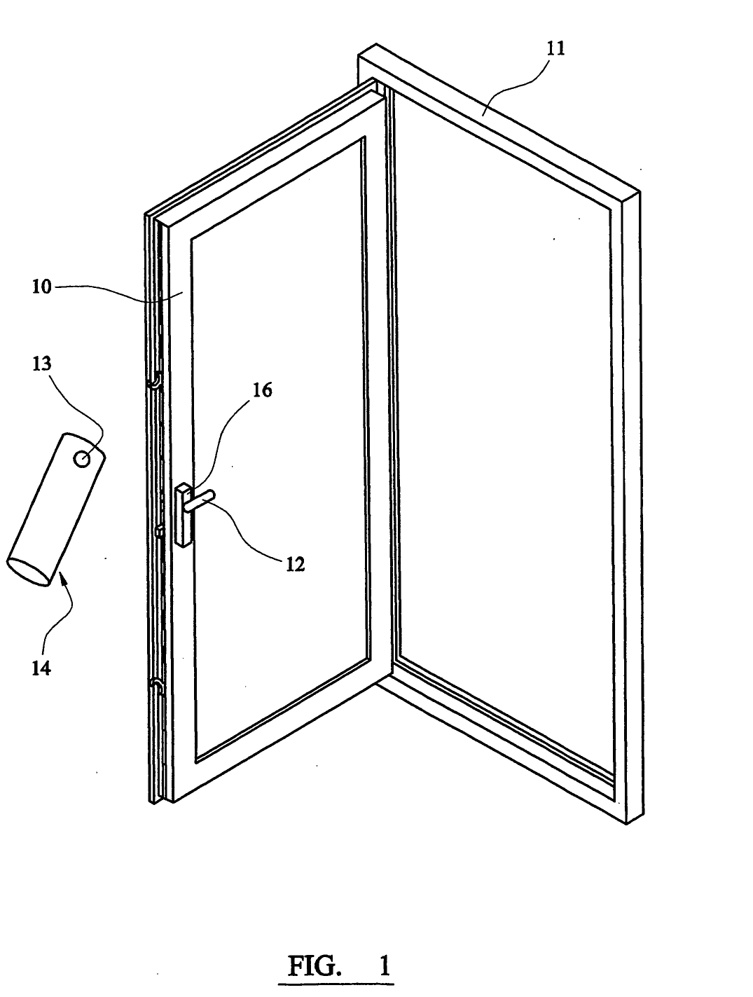

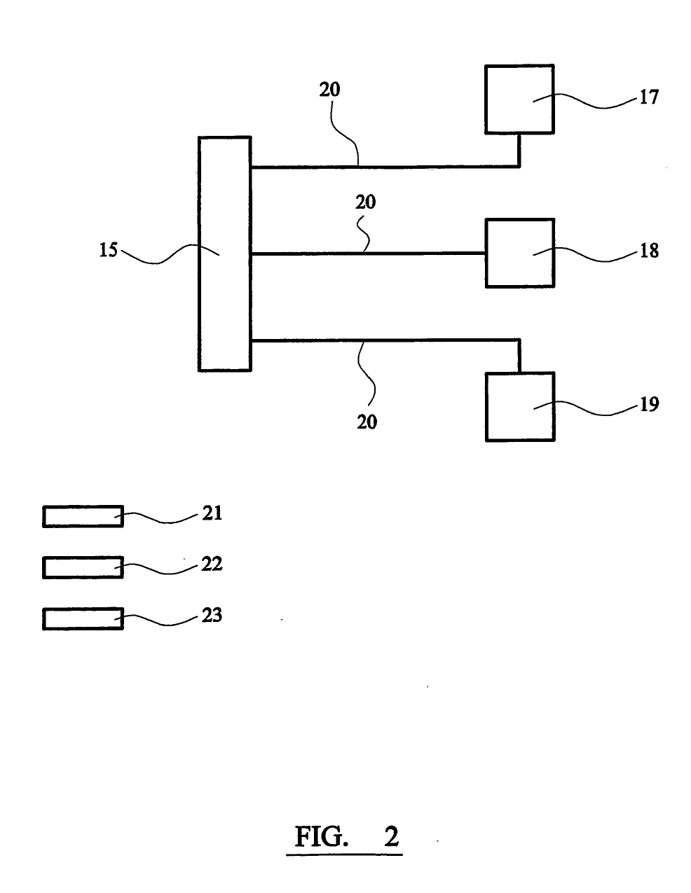

By way of example, a specific embodiment of the invention will now be described, with reference to FIGS. 1 and 2 of the accompanying drawings.

FIG. 1 is a diagrammatic illustration of a door fitted with an embodiment of locking mechanism according to the invention; and FIG. 2 is a diagrammatic view of a control system for the locking mechanism.

FIG. 1 illustrates an external house door 10 hinged to a frame 11. An internal handle 12 is visible in FIG. 1 and there is a similar external handle which is not visible in the drawings.

The door can be locked in the closed position in any desired manner, and can be unlocked from outside the house by pressing a button 13 on a fob 14 shown in FIG. 1 to an enlarged scale.

During normal operation of the door, only the fob 14 is required.

However, referring to FIG. 2, the electronic components 15 of the door locking mechanism 16 are associated with three internal safety devices, namely a smoke detector 17, a burglar alarm 18 and a panic button 19.

These safety devices may be connected to the components 15 by hard wiring 20, or they may communication remotely, using radio signals for example. The panic button 19 in particular may operate remotely, since such devices are commonly carried by householders in their pocket or handbag, for example for the benefit of an elderly or infirm householder who may suffer a fall or other medical emergency.

In the locality of the house, fire officers are provided with a specifically coded type of fob 21. Police officers are provided with a differently coded fob 22 and health officers such as district nurses are provided with a third type of coded fob 23.

Even if the door is securely locked, activation of the smoke detector 17 makes the locking mechanism receptive to an unlocking signal from the fob 21. Activation of the burglar alarm 18 makes the locking mechanism receptive to an unlocking signal from the fob 22, and activation of the panic button 19 makes the locking mechanism susceptible to an unlocking signal from the fob 23.

Thus, whatever situation develops within the house, the appropriate authorised official can gain entry, but only those appropriately authorised to deal with that particular situation.

Although the invention may be used with any desired locking mechanism, a particularly convenient locking mechanism is that described in our co-pending international patent application claiming priority from application GB 0200677.3

The reader's attention is directed to all papers and documents which are filed concurrently with or previous to this specification in connection with this application and which are open to public inspection with this specification, and the contents of all such papers and documents are incorporated herein by reference.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings), may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extends to any novel one, or any novel combination, of the features disclosed in this specification (including any accompanying claims, abstract and drawings), or to any novel one, or any novel combination, of the steps of any method or process so disclosed.

1. A locking mechanism operable to restrict unauthorised access to a structure such as a house, the locking mechanism being operable, to permit external access, by means of at least two remote control devices operable from outside the structure, one of the remote control devices being arranged for use by an occupant of the structure and another of the remote control devices being arranged for use by an authorised official such as a police officer, fire officer or safety officer (e.g. doctor, nurse, paramedic or ambulance personnel).

2. A locking mechanism as claimed in claim 1, associated with at least one internal safety device, for example a smoke detector or panic button, the locking mechanism being such that if the safety device is activated this makes the locking mechanism susceptible to an entry signal from an associated external operating device.

3. A locking mechanism as claimed in claim 2, such that if a smoke detector within a house is operated, then this will put the locking mechanism into a condition in which an operating device specifically allocated to fire officers will enable a fire officer to gain access to the house.

4. A locking mechanism as claimed in claim 2, such that if a panic button is activated within a house, a doctor, nurse, paramedic or the like can gain access.

5. A locking mechanism as claimed in claim 1, in which at least one of the remote control devices comprises a fob.

6. (canceled)

7. A structure when fitted with a locking mechanism operable to restrict unauthorised access to a structure such as a house, the locking mechanism being operable, to permit external access, by means of at least two remote control devices operable from outside the structure, one of the remote control devices being arranged for use by an occupant of the structure and another of the remote control devices being arranged for use by an authorised official such as a police officer, fire officer or safety officer (e.g. doctor, nurse, paramedic or ambulance personnel).

8. A locking mechanism as claimed in claim 3, such that if a panic button is activated within a house, a doctor, nurse, paramedic or the like can gain access.
